(19) United States
(12) Patent Application Publication
(10) Pub. No.: US 2006/0122879 A1
(43) Pub. Date: Jun. 8, 2006

(54) Method and system for pricing electronic advertisements

(76) Inventor: Brian O'Kelley, New York, NY (US)

Correspondence Address: CLOCK TOWER LAW GROUP, 2 CLOCK TOWER PLACE, SUITE 255, MAYNARD, MA, 01754-2545, US

(21) Appl. No.: 11/006,121

(22) Filed: Dec. 7, 2004

(51) Int. Cl. G06Q 30/00; G06F 17/00

(52) U.S. Cl. 705/14; 705/400

(57) ABSTRACT

A system and method of pricing an electronic advertisement that includes receiving a request for an electronic advertisement to be presented to a visitor, setting a price of the electronic advertisement, and presenting the electronic advertisement to the visitor.

### CROSS REFERENCE TO RELATED APPLICATIONS

This application is related to the following application, which is incorporated herein by reference in its entirety: U.S. patent application Ser. No. 10/964,951 entitled “System And Method For Learning And Prediction For Online Advertisement” filed on Oct. 14, 2004.

### BACKGROUND OF THE INVENTION

1. Field of the Invention

The invention relates generally to management and delivery of electronic advertising, and relates particularly to pricing of electronic advertisements.

2. Description of Prior Art

Advertising on the Internet has become a popular and effective way of promoting goods and services. The interactive nature of the Internet has provided opportunities for better targeting in advertising. This interactive nature has also led to new pricing models for advertisements. With Internet advertising systems capable of recording viewer actions associated with electronic advertisements, pricing models can be based on such actions.

For example, a common online advertising method is the banner advertisement.

The banner advertisement is usually a combination of text and graphics of a specific size appearing on the top of or along the side of a web page. If the content of such a banner advertisement interests an online visitor, the visitor can click on the banner advertisement for more information or to purchase a product.

If a visitor clicks on an electronic advertisement, then the advertising system that published the electronic advertisement is notified. After clicking on the advertisement, the visitor may subsequently act on or convert on the advertisement.

A visitor can act or convert on an advertisement in several ways including, but not limited to, purchasing a product, ordering services, submitting an email address, or answering a question. If the visitor subsequently acts on or converts on the advertisement, then the publishing system is also notified.

An advertiser or owner of such advertisements may then be charged based on the visitor's viewing impressions, clicks, or conversions. Thus pricing models for electronic advertisements include cost-per-thousand impressions (CPM), cost-per-click (CPC), and cost-per-action (CPA). Pricing models have become an important consideration for advertisers trying to maximize their return on investment (ROI), and for publishers trying to maximize revenue from advertisement management and display services.

Such pricing models have been combined with bidding systems allowing advertisers to adjust the price they are willing to pay for each advertisement. Some bidding systems include targeting rules based on historical performance. The historical performance is usually evaluated at arbitrary intervals. Most other systems use rule sets to determine which advertisement will produce the highest ROI.

For example, Overture (http://www.content.overture.com/d/USm/about/advertisers/sp_intro.jhtml) is a pay-for-placement (P4P or PFP) service that allows advertisers to purchase search terms so that when users search for those search terms on search engines such as Yahoo (http://www.yahoo.com/), MSN (http://www.msn.com/), and Altavista (http://www.altavista.com/), the advertiser's advertisement will appear as impressions, typically labeled as a “sponsored link” or the like. Advertisers can associate each search term with a target URL. In one model, Overture charges for clicks but not for impressions (i.e. it is a CPC-based model, not a CPM-based model). Using this CPC-based model, advertisers determine how much they want to pay for each search term. Then they check Overture's reports (for example monthly) to see how many clicks each search term generated and what the CPC was for each search term. Advertisers can discard non-performing search terms (i.e. those with no clicks), and advertisers can spend more money on performing search terms (i.e. those with clicks). One problem with this system is that an advertiser's budget can be quickly exhausted by a few search terms with a high cost, i.e. those with many clicks where the advertiser payed a high amount for the search terms. Another problem with this system is that advertisers must constantly monitor the performance of all search terms and all search engines in an attempt to efficiently acquire the most conversions.

There are also a number of patents that relate to electronic advertisement pricing and management.

U.S. Pat. No. 6,026,368 “On-Line Interactive System And Method For Providing Content And Advertising Information To A Targeted Set Of Viewers” (Brown et al. 02-15-2000) describes a system for targeting and providing advertisements in a prioritized manner. A queue builder generates priority queues. Content data and subscriber data is sent to the queue builder. An online queue manager receives priority queues from the queue builder and sends content segment play lists over a network.

U.S. Pat. No. 6,285,987 “Internet Advertising System” (Roth et al. 09-04-2001) describes a system that uses a central server to provide advertisements based on information about viewers who access web sites. A database stores advertisements, information about viewers, and characteristics of a web site.

Advertisers specify proposed bids in response to specific viewing opportunities, bidding agents compare characteristics of viewing opportunities to specifications in proposed bids, then the bidding agents submit bids as appropriate.

U.S. Pat. No. 6,324,519 “Advertisement Auction System” (Eldering 11-27-2001) describes an auction system that uses consumer profiles. When a consumer is available to view an advertisement, advertisers transmit advertisement characterization information which is correlated with a consumer profile. Advertisers place bids for the advertisement based on the advertisement characterization and the subscriber profile.

U.S. Pat. Application No. 2002/0116313 “Method Of Auctioning Advertising Opportunities Of Uncertain Availability” (Detering 08-22-2002) describes a method of determining pricing and allocation of advertising messages. Before an advertising opportunity occurs, bids are organized around profiles of individuals. Advertisers specify their audience preferences and a ranking list of potential contacts is drawn from a database of profiled individuals and displayed to the advertisers. Advertisers then enter their maximum bid and/or bidding criteria for contacting each of the displayed contacts.

U.S. Pat. Application No. 2003/013546 “Methods For Valuing And Placing Advertising” (Talegon 07-17-2003) discloses a method for valuing and placing advertisements based on competitive bidding. Publishers make advertisement space available to an intermediary who accepts bids from advertisers and awards advertising space based on ranking.

U.S. Pat. Application No. 2003/0220918 “Displaying Paid Search Listings In Proportion To Advertiser Spending” (Roy et al. 11 -27-2003) describes a pay for placement database search system. Advertisers pay for their search listings to be provided with search results in response to queries from searchers.

U.S. Pat. Application No. 2004/0034570 “Targeted Incentives Based Upon Predicted Behavior” (Davis 02-19-2004) describes a system for anticipating and influencing consumer behavior. Consumers receive targeted incentives based upon a prediction about whether the consumer will enter into a transaction.

U.S. Pat. Application No. 2004/0068436 “System And Method For Influencing Position Of Information Tags Allowing Access To On-Site Information” (Boubek et al. 04-08-2004) describes a method of advertising on the Internet. Information providers influence the position of their information tags by auctioning directory search terms associated with the information tag. The information tags allow consumers access to information maintained on the same website as the information tag.

While the prior art discloses attempts to improve pricing models for Internet advertisements, these attempts generally focus on making rule sets for bidding based on historical data. The analysis for making rule sets is done off-line or at specified time intervals. Much of the advertiser's time is spent adjusting bidding amounts and strategies. Prior attempts do not concentrate analysis at the individual advertisement level. Furthermore, prior attempts either maximize revenue for the publisher or maximize ROI for the advertiser—but not both. What is needed, therefore, is a method of pricing advertisements at the individual level, using real time data, in a manner that maximizes revenue for the publisher and maximizes ROI for the advertiser.

### BRIEF SUMMARY OF THE INVENTION

Overview

The present invention is a method of pricing electronic advertisements. The invention provides:
1) Dynamic Pricing. The invention provides the ability to set a price for an advertisement at run time based upon the “advertiser value,” namely the value of the advertisement as determined by the advertiser (based on past performance or other criteria).
2) Pricing based on “soft targets.” The invention provides the ability to determine whether a predetermined price meets an advertiser's soft targets. “Soft targets” are CPC-based or CPA-based ROI targets based on the projected actions of the visitor.
3) Auction-based pricing. The invention provides the ability for the advertiser to pay only as much as necessary to secure the impression, while insuring the advertiser does not pay more than the advertisement is worth. This process maximizes publisher revenue while ensuring that advertisers meet their ROI goals.

As an electronic advertisement pricing system, the invention may be integrated with or operate as a component of a larger advertisement serving system. An advertisement serving system using the present invention may manage all interactions with advertisers and users including creative content, session management, reporting, targeting, trafficking, and billing. Such a system may include a mechanism or component, either online or off-line, to predict how likely a visitor is to convert on a particular advertisement.

The ROI for an advertiser's campaign is usually calculated after a campaign has been completed. Each visitor action can be assigned some value by the advertiser to calculate the return on investment (ROI) for the advertising campaign. For example, an advertiser may assign one value for clicking an electronic advertisement, a second value for filling out a form, a third value for subscribing to a newsletter, a fourth value for purchasing a product, and so on. In the following formula, “n” is a binary number representing whether or not a particular action occurred (i.e. “n” is equal to one if the action occurred, “n” is equal to zero if the action did not occur), and “r” represents the value of the corresponding action. So
1) if nₐ represents the a^{th} action and rₐ represents the value of the a^{th} action; and
2) if n_{b} represents the b^{th} action and r_{b} represents the value of the b^{th} action; and
3) if nₓ represents the x^{th} action and rₓ represents the value of the x^{th} action;
then the ROI can be represented as:

$$campaignROI = \frac{( ( {n}_{a} \times {r}_{a} ) + ( {n}_{b} \times {r}_{b} ) + … + ( {n}_{x} \times {r}_{x} ) )}{campaignCost}$$

When, as in other systems, the cost of an impression is fixed, the above equation becomes:

$$campaignROI = \frac{( ( {n}_{a} \times {r}_{a} ) + ( {n}_{b} \times {r}_{b} ) + … + ( {n}_{x} \times {r}_{x} ) )}{fixedCost}$$

where fixedCost represents the fixed cost of a particular campaign. When the cost of a campaign is fixed, the only way to increase the ROI is increase the value of rₓ, which is usually only possible by changing the advertised product itself to make it more valuable, which may not be possible or practical.

When advertisers have a minimum acceptable ROI (and therefore a range of acceptable ROIs), then the value of the campaign cost (campaingCost) can be varied to stay within the range of values of acceptable ROI:

$$( campaignROI \geq minimumAcceptableROI ) = \frac{( ( {n}_{a} \times {r}_{a} ) + ( {n}_{b} \times {r}_{b} ) + … + ( {n}_{x} \times {r}_{x} ) )}{campaignCost}$$

In this scenario, the advertisement server can increase each impression price to decrease the advertiser's campaign ROI without having the ROI go below the minimum acceptable ROI. Similarly, the advertisement server can decrease each impression price to increase the advertiser's campaign ROI. In this way, the present invention calculates a projected ROI when an advertisement is run (i.e. in real time).

The projected ROI is calculated using a “conversion probability,” which is the probability of visitor action such as the probability that a user will click on a particular impression, or the probability that a user will convert on a particular impression. The projected ROI calculation also uses an impression cost. The impression cost is set by the publisher and is within a range of acceptable values. Using a probability of a visitor action and an impression cost, the invention calculates a projected ROI for a particular advertisement and online visitor. If pₓ represents the probability that an online visitor will act on action x if this advertisement is shown to the online visitor (i.e. “p” is a value between or including zero and one), then the projected ROI for the next impression is:

$$impressionROI = \frac{( ( {p}_{a} \times {r}_{a} ) + ( {p}_{b} \times {r}_{b} ) + … + ( {p}_{x} \times {r}_{x} ) )}{impressionCost}$$

So the formula to calculate the impression cost (impressionCost) becomes:

$$impressionCost = \frac{( ( {p}_{a} \times {r}_{a} ) + ( {p}_{b} \times {r}_{b} ) + … + ( {p}_{x} \times {r}_{x} ) )}{impressionROI}$$

The projected value of an action is calculated by multiplying each action's probability times its value (e.g. (pₐ×rₐ)), and the projected value of an impression is calculated by summing these results for each action (the numerator of the right half of the above formula). By dividing this projected value of an impression by the calculated ROI, the impression cost can be calculated. By setting the impression cost at a price the publisher will accept, the system can maximize revenue for a publisher while still meeting ROI goals of the advertiser. Advertisers have the option of specifying maximum and minimum price constraints as well as ROI targets. The system may adjust the final maximum price as the lesser of the advertiser's price constraint and the ROI-derived impression cost.

For example, an advertiser's definition of a “lead” could be a user who say an advertisement (an impression), clicked on it, and acted on it by filling out a form. Rather than paying a certain amount for each click associated with a search term (as in the Overture example), the advertiser determines that it is willing to pay $20 for a lead, and the system adjusts the amount the advertiser is willing to pay for advertisements from all providers to archive the $20/lead goal. This is the opposite of how Overture works, where users set prices for search terms, not for leads.

Features and Advantages

An advantage of this invention is that it provides the ability to 1) set a price for an advertisement at run time based upon the value of the advertisement to the advertiser (pricing dynamically) and 2) determine whether a predetermined price is advantageous for the advertiser (pricing based CPC or CPA soft targets).

Another advantage of this invention is that it maximizes publisher revenue while ensuring that advertisers meet their ROI goals. The invention calculates an advertiser's projected ROI and a publisher's expected CPM (eCPM) in real time, not at intervals, so pricing of each electronic advertisement is more efficient for both advertisers and publishers.

Another advantage of the invention is that it focuses on the individual advertisement level and not in the aggregate. This individual advertisement focus is also done automatically, eliminating the need for advertisers to spend time reviewing each advertising opportunity. Advertisers may designate a target ROI for their campaign instead of focusing on bidding and pricing strategies. Advertisements can be targeted by market segment and by target website.

Another advantage is accurate pricing of individual advertisements. In prior systems, advertisers attempted to maximize their ROI by adjusting the amount they are willing to pay for advertising during the campaign. This can be inefficient as the advertiser pays the same amount for a high-quality impression as for a low-quality impression. So without dynamic pricing, if an advertiser sets its price too low, then it won't get any delivery, and if the price is too high, then the advertiser will not meet its ROI goals. With pricing based on a projected ROI, however, each individual advertisement is accurately priced so that advertisers are getting the most value from each advertisement impression. Additionally, advertisers can run campaigns by focusing more on ROI targets rather than bidding strategies.

### BRIEF DESCRIPTION OF THE DRAWINGS

In the drawings, closely related figures and items have the same number but different alphabetic suffixes. Processes, states, statuses, and databases are named for their respective functions.

FIG. 1 is a diagram showing the overall advertisement serving process and pricing system.

FIG. 2 is a flow chart of the pricing process.

FIG. 3 shows a client-server environment for the invention.

FIGS. 4-6 are flow charts showing component processes of the pricing system.

### DETAILED DESCRIPTION OF THE INVENTION, INCLUDING THE PREFERRED EMBODIMENT

Operation

In the following detailed description of the invention, reference is made to the accompanying drawings which form a part hereof, and in which are shown, by way of illustration, specific embodiments in which the invention may be practiced. It is to be understood that other embodiments may be used, and structural changes may be made, without departing from the scope of the present invention.

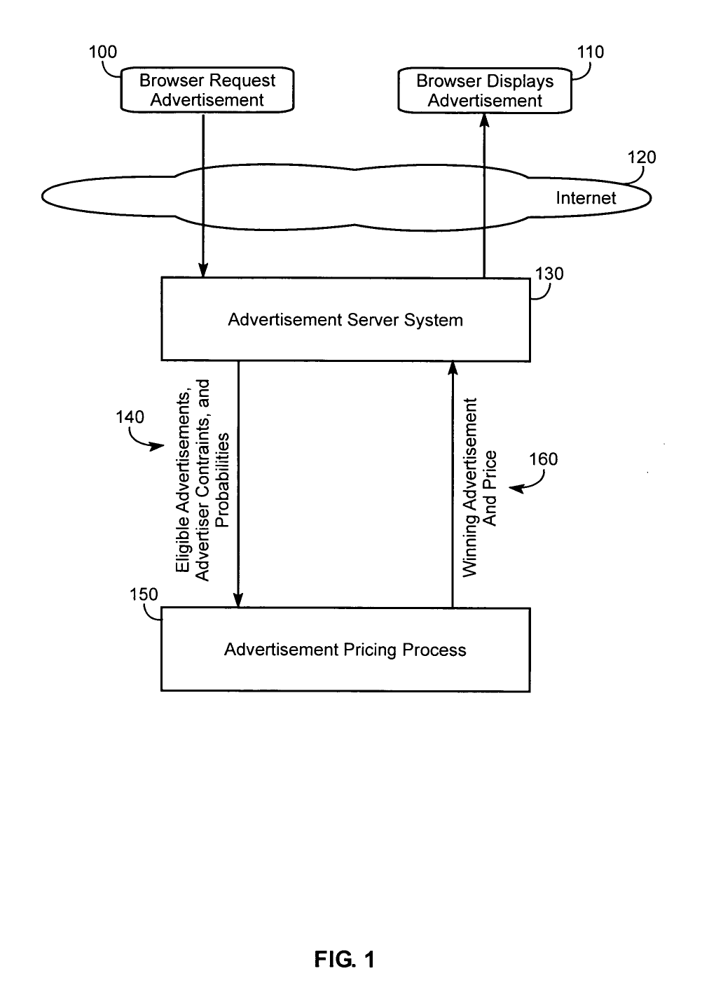

FIG. 1 shows the process of serving an advertisement over the Internet and how the pricing process of the present invention fits into Internet advertisement serving systems. In the course of using the Internet 120, a person may use a web browser on a client computer (not shown) to visit a website on a server computer (not shown) running a web server (not shown). Upon connecting to this website, and while navigating through web pages on this website, the website has an opportunity to presented advertisements to the visitor. For simplification, the following discussion refers to “display” of advertisements, but advertisements can have visual components, audio components, text components, other components, or any combination of the above. Every advertisement displayed to the visitor is termed an impression.

Certain web pages are designed to display an advertisement impression to the visitor. At block 100, the visitor's browser requests an advertisement from advertisement server system 130. Upon receiving the advertisement request from the browser, advertisement server system 130 specifies a list of eligible advertisements for consideration, advertiser constraints, and visitor action probabilities in step 140. Advertising pricing process 150 receives the eligible advertisements, constraints, and probabilities for selecting and pricing an advertisement. After pricing and selection of an advertisement, advertising pricing process 150 sends, in step 160, a winning advertisement and its price to advertisement server system 130. Advertisement server system 130, in conjunction with the web server (not shown), then returns the selected advertisement to the web browser. In block 110, the web browser displays the selected advertisement to the visitor. By a combination of web browser session data, web browser cookies, and HTTP calls from the websites visited by the users to the advertisement server system 130, click data and conversion data is calculated.

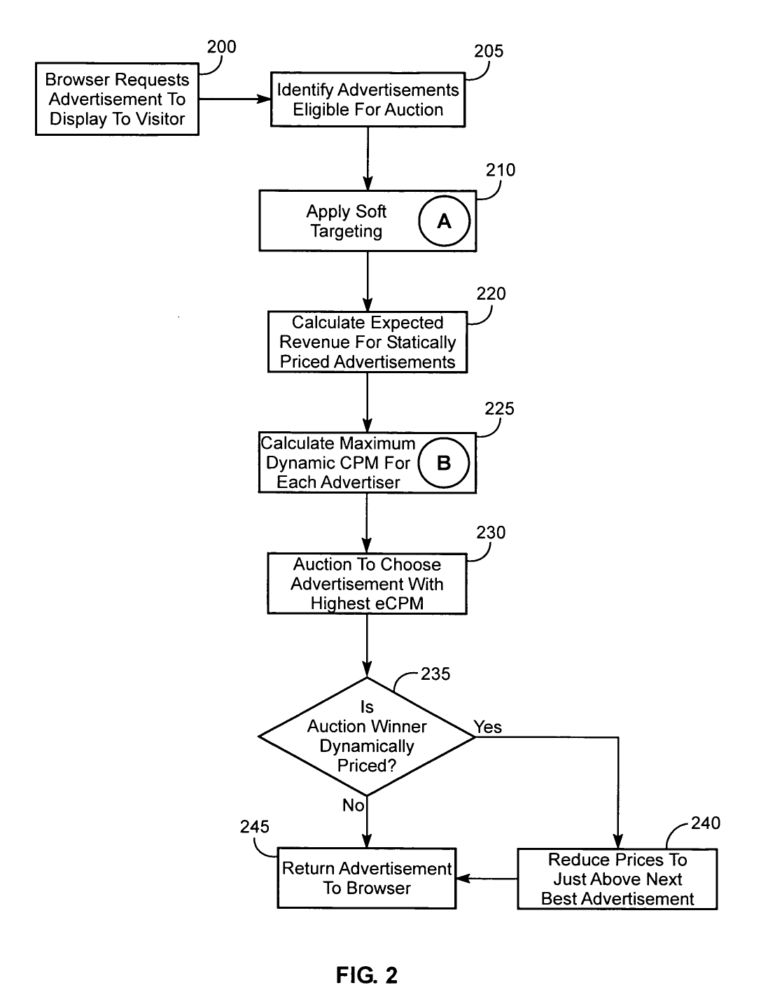

FIG. 2 shows a detailed decision process for pricing electronic advertisements. In block 200, a browser requests an advertisement to display to a visitor. In block 205, electronic advertisements that are eligible for auction are identified. This identification process is called “hard targeting.” Hard targeting rules for advertisements can be based on any number of factors including, but not limited to, size of the advertisement, geography, frequency cap, website or section exclusions, creative or advertiser bans. Eligibility may be based on several factors such as format of advertisement, or size of advertisement. For example, a browser may have a space available for a 120×600 pixel banner advertisement. When the browser requests an advertisement for this space, only those advertisements fitting this size requirement will be considered. The requested advertisement may also be restricted to a ”.gif” image, must contain flash animation, must be a text-based advertisement, or other such restriction. Eligibility of an advertisement may also be based on content of an advertisement. A user may enter search terms into a search engine, in which case only advertisements associated with the search term would be eligible. The browser or website may request specific content such as, for example, a mobile phone advertisement. In such a request, only advertisements with content relating to mobile phones will be considered. Another eligibility factor can be type of advertisement. Advertisements may be banner advertisements, advertisements providing a game for a visitor to play, floating advertisements, HTML emails, and so forth. Requests for HTML emails may come from a browser or from a separate marketing engine.

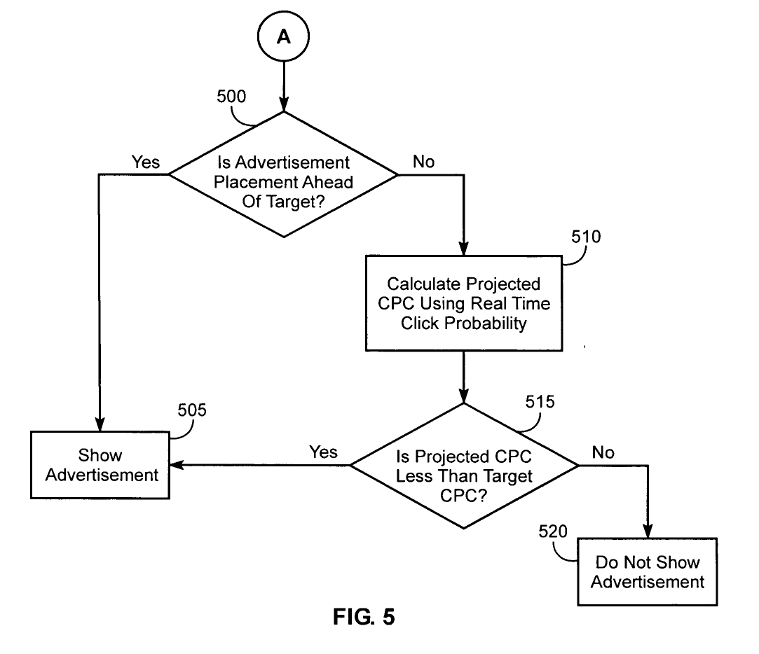

Continuing now with FIG. 2. The system next applies soft targeting (block 210) (FIG. 5, via off-page connector A). “Soft targets” are CPC-based or CPA-based ROI targets based on the projected actions of the visitor. Soft targeting is performed at the advertisement placement level. If the placement is ahead of its CPC or CPA soft target, the system can show any advertisement. If the placement is behind this target, the system may operate by only showing advertisements that the invention predicts to be at or below the target.

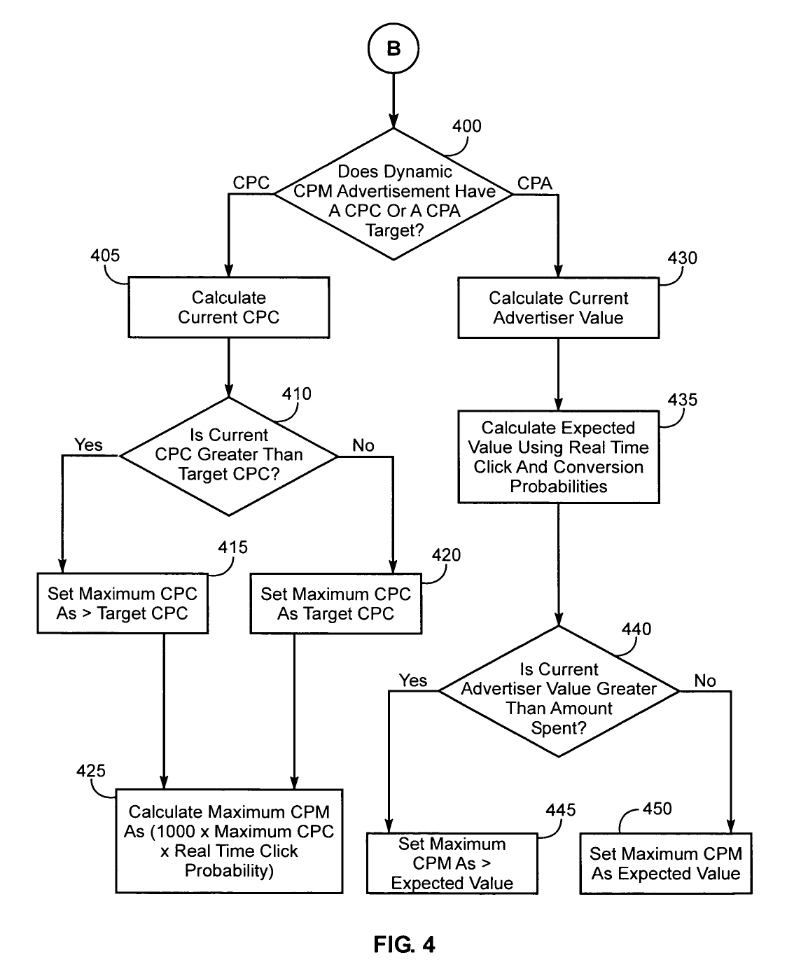

Continuing now with FIG. 2. At block 220, expected revenue for statically priced electronic advertisements is calculated. At block 225, the system calculates a maximum price for flexibly priced CPM advertisements for each advertiser (FIG. 4, via off-page connector B). After the system calculates the maximum dynamic CPM for each advertiser, an auction is conducted to choose the electronic advertisement with the highest expected revenue (eCPM) for the publisher (block 230), which is the “best electronic advertisement.” If the best electronic advertisement (the auction winner) is a dynamically priced electronic advertisement (block 235), then the price of the best electronic advertisement is lowered to a point just greater than the second-best electronic advertisement from the auction (block 240), and then the best electronic advertisement is returned to the browser (block 245). If the best electronic advertisement is not a dynamically priced electronic advertisement (block 235), then the best electronic advertisement is returned to the browser (block 245).

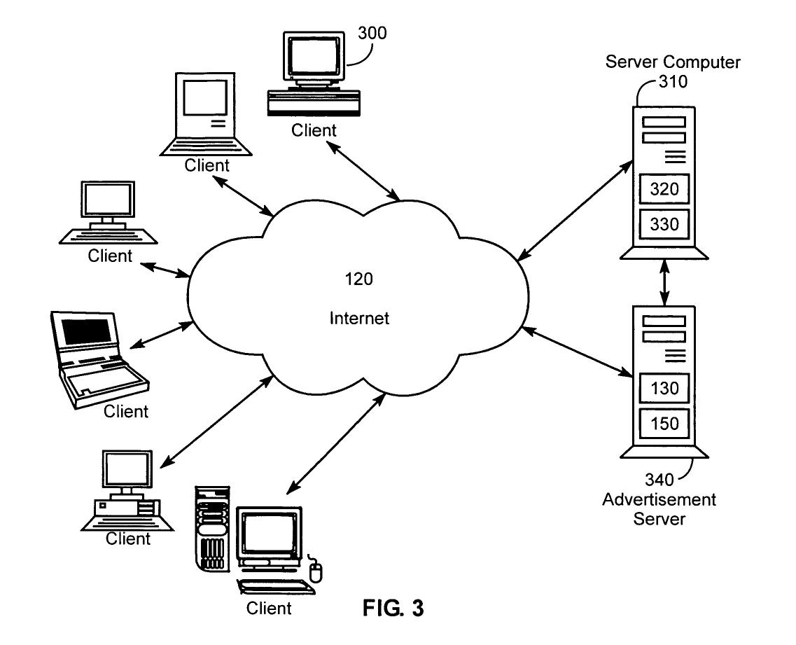

FIG. 3 shows a client-server environment for the invention. One or more client computers 300 connect via Internet 120 to server computer 310, which is operative to run a web server 320 and a database server 330. The database server 330 serves data from a database (not shown), which stores electronic advertisements, advertiser data, publisher data, and related data. The server computer 310 communicates with and operates in conjunction with advertisement server 340, which is operative to run the advertisement server system 130 and the advertisement pricing process 150. In the preferred embodiment, the advertisement server system is implemented in the C programming language, and the database is Berkeley DB. It is to be understood that the web server, database server, and advertisement server can be configured to run on one or multiple physical computers in one or more geographic locations, that alternate platforms can be used for the database and for each server, and that alternate programming languages can be used.

FIG. 4 shows the process of FIG. 2, block 225, in more detail. Beginning at block 400, the system determines if the dynamic CPM advertisement has a CPC or CPA target. For dynamic CPM advertisements with CPC targets, at block 405, the system calculates the current CPC as the amount spent divided by the number of clicks. If the current CPC is greater than the target CPC, block 410, then the maximum CPC is set to an amount greater than target CPC, block 415. Otherwise, the the maximum CPC is set to an amount equal to the target CPC, block 420.

Then a maximum CPM is calculated as the product of 1) 1000, 2) the calculated maximum CPC, and 3) a real time click probability, block 425.

Continuing with FIG. 4. For dynamic CPM advertisements with a CPA target, the system begins by calculating the current advertiser value, block 430. The current advertiser value is, for each advertisement, the sum of the product of the 1) conversion targets and 2) the number of conversions. At block 435 the system calculates the expected value of the CPM advertisement. If the current advertiser value is greater then the amount spent, block 440, then the maximum CPM is set to an amount greater than the expected value, block 445. Otherwise the system sets the maximum CPM to an amount equal to the expected value, block 450.

FIG. 5 shows the process of FIG. 2, block 210, in more detail. FIG. 5 is illustrative of the soft targeting process and shows a flow diagram for soft targeting of a CPM advertisement with a CPC target. If a CPC advertisement is ahead of its target, block 500, then the considered advertisement can be shown. Otherwise, the system calculates a projected CPC using a real time generated click probability, block 510. If the projected CPC is less than or equal to a target CPC, then the advertisement can be shown, block 505. Otherwise, don't show the advertisement, block 520.

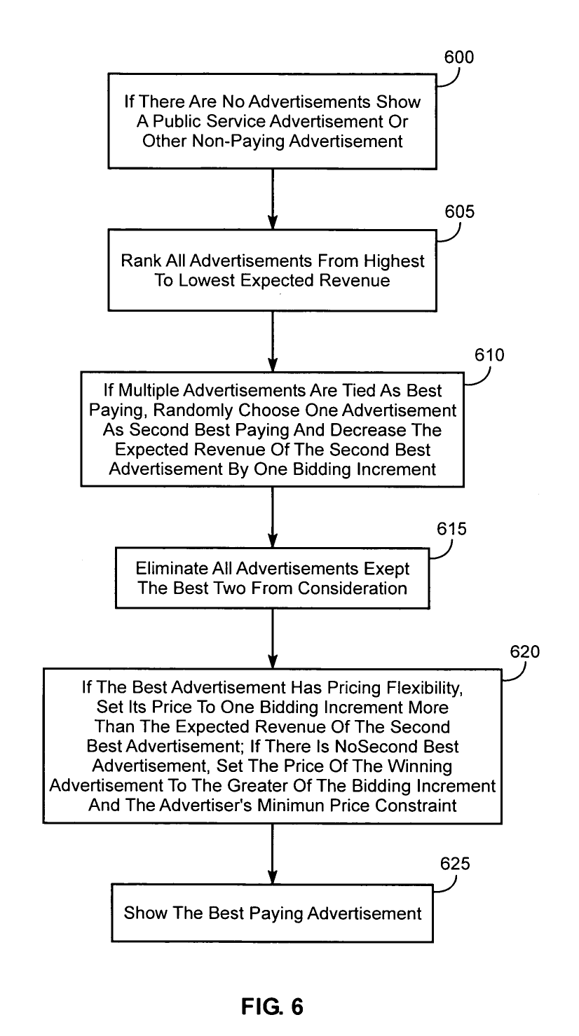

FIG. 6 shows the preferred bidding method. As described in blocks 600 to 625, if there are no advertisements, show a public service advertisement or other non-paying advertisement (600). Next, rank all advertisements from highest to lowest expected revenue (605). If multiple advertisements are tied as the best, randomly choose one advertisement as the winner and one advertisement as the second-best, then decrease the expected revenue of the second-best advertisement by one bidding increment (610). Eliminate all advertisements except the best two from consideration (615). If the best advertisement has pricing flexibility, set its price to one bidding increment more than the expected revenue of the second-best advertisement. If there is not a second-best advertisement, set the price of the winning advertisement to the greater of the bidding increment and the advertiser's minimum price constraint (620). The best advertisement is then shown to the visitor (625).

### Other Embodiments

The system may consider combinations of advertisement pricing models such as CPC, CPA, and flat-rate CPM. Visitor action probabilities are also used with these pricing models to predict an expected revenue for each type of pricing model considered. When combining pricing models, the system calculates an expected revenue for the publisher for each advertisement considered.

1) For CPA advertisements, an expected revenue is the product of the conversion probability and the value of such a conversion.

2) For CPC advertisements, the expected revenue is the product of the click probability and the advertiser's value of such a click.

3) For fixed price CPM advertisements, the expected revenue is the fixed cost of the advertisement.

4) For dynamically priced CPM advertisements, the expected revenue is the maximum dynamic CPM as calculated previously following the steps as shown in FIG. 2. The maximum dynamic CPM may be selected as the lesser of the calculated maximum dynamic impression cost (maximum impression cost), and an advertiser's assigned maximum price. The formulas for expected revenues are:
expRevDYN=maximumImpressionPrice
expRevCPA=((pₐ×rₐ)+(p_{b}×r_{b})+. . . +(pₓ×rₓ))
expRevCPC=(p_{click}×r_{click})
expRevCPM=rᵢₘₚ

Once each advertisement has been assigned an expected revenue, the system can select the advertisement with the highest expected revenue to return to the browser. Alternatively, the system may hold an auction wherein those advertisements with flexible pricing may have their price incrementally raised, according to the publisher's and the advertiser's bidding rules, until there is a winner.

1. A method of pricing an electronic advertisement, the method comprising the steps of:
receiving a request for an electronic advertisement to be presented to a visitor;
setting a calculated price of said electronic advertisement using a conversion probability and an advertiser value; and
returning said electronic advertisement to be presented to said visitor.

2. The method of claim 1, wherein said electronic advertisement is returned when said calculated price meets a threshold price requirement.

3. The method of claim 1, further comprising selecting multiple electronic advertisements for calculating a price and returning an electronic advertisement of said multiple electronic advertisements having a highest calculated price.

4. The method of claim 1, wherein said conversion probability is a variable number calculated by tracking actual impressions, clicks, and conversions for said electronic advertisement.

5. The method of claim 1, wherein said conversion probability is a variable number calculated by tracking predicted impressions, clicks, and conversions for said electronic advertisement.

6. A method of selecting a best priced electronic advertisement from a group of dynamically priced and statically priced electronic advertisements comprising:
calculating expected revenue for all statically priced electronic advertisements;
calculating maximum expected revenue for all dynamically priced electronic advertisements;
conducting an auction to select the best electronic advertisement, wherein the best electronic advertisement is one from said group with the highest expected revenue; and
if the best electronic advertisement is dynamically priced, lowering the price of said best electronic advertisement to a point just greater than the second-best electronic advertisement from said auction.

7. A method of selecting an electronic advertisement to present to a visitor comprising:
receiving a request to present an electronic advertisement;
identifying electronic advertisements eligible to present; and
applying soft targeting to said electronic advertisements to eliminate those electronic advertisements that do not meet ROI targets for advertisers.

8. A method of pricing an electronic advertisement, the method comprising:
receiving a request for an electronic advertisement;
specifying a list of eligible electronic advertisements to return;
calculating a price for each of said eligible electronic advertisements based on real time projected performance of each of said electronic advertisements and an advertiser's ROI constraints for each of said electronic advertisements; and
choosing an electronic advertisement that will provide a publisher a highest revenue given said ROI constraints established by said advertiser.

9. The method of claim 8, wherein said choosing includes holding an auction.

10. A method of pricing an electronic advertisement, the method comprising
receiving a request for an electronic advertisement to be presented to a visitor;
calculating a projected ROI for each electronic advertisement considered for selection, wherein each said projected ROI is calculated using a contemporaneously calculated conversion probability, an advertiser value, and an impression cost;
calculating an impression price for said electronic advertisement for each electronic advertisement considered for selection having a projected ROI satisfying a ROI threshold, wherein said impression price is calculated using said contemporaneously calculated conversion probability and said advertiser value; and
selecting and returning an electronic advertisement having a highest impression price.

11. The method of claim 10, further comprising adjusting an impression price for each electronic advertisement to the lesser price of an advertiser's price constraint and said calculated impression price.

12. The method of claim 10, wherein said selecting and returning comprises auctioning electronic advertisements, having a calculated impression price, by incrementally increasing said calculated impression prices until individual price constraints for each electronic advertisement yield a winning electronic advertisement having a final impression price.

13. The method of claim 12, wherein only a portion of said electronic advertisements, comprising electronic advertisements having highest calculated prices, are considered for said auctioning.

14. The method of claim 10, wherein said advertiser value is assignable and modifiable by an advertiser.

15. A method of dynamically setting the price of an electronic advertisement, the method comprising:
receiving a request for an individual electronic advertisement from a web browser;
calculating an expected revenue for a publisher for each electronic advertisement with flexible pricing selected and eligible for consideration, wherein said expected revenue for said flexibly-priced electronic advertisements is calculated using a conversion probability and an advertiser value;
calculating an expected revenue for each electronic advertisement with fixed-rate pricing, wherein for each fixed-rate electronic advertisement said expected revenue is calculated using a real time conversion probability; and
returning an advertisement having a highest expected revenue to said web browser.

16. The method of claim 15, further comprising adjusting a price of said flexibly-priced electronic advertisements by auction to yield a final expected revenue of said flexibly priced electronic advertisements for consideration in selecting a highest-priced electronic advertisement.

17. The method of claim 15, wherein for cost-per-click electronic advertisements, a real time calculated probability of a click is used.

18. The method of claim 15, wherein for cost-per-action electronic advertisements, a real time calculated probability of conversion is used.

19. A method of dynamically setting the price of an electronic advertisement, said method comprising the steps of:
receiving a request for an electronic advertisement to be presented to a visitor;
calculating a projected ROI for each advertiser from each electronic advertisement considered for selection, wherein each said projected ROI is calculated by multiplying a real time conversion probability with an advertiser value, and then dividing by an impression cost set by a publisher;
calculating an impression price for each electronic advertisement considered for selection, wherein said impression price is calculated by multiplying said real time conversion probability with an advertiser value; and
selecting and returning an electronic advertisement having a highest calculated impression price.

20. The method of claim 19, further comprising determining a maximum impression price for each electronic advertisement considered for selection by selecting a lesser price between said calculated impression price and a price -limit set by an advertiser.

21. The method of claim 19, further comprising:
calculating an expected revenue from fixed-rate electronic advertisements by multiplying a real time conversion probability with a fixed rate; and
selecting a highest paying electronic advertisement among said fixed-rate electronic advertisements, said electronic advertisements with a calculated impression price, and electronic advertisements with a fixed impression price.

22. The method of claim 19, further comprising:
ranking electronic advertisements by expected revenue and selecting a first and second highest paying electronic advertisement; and
auctioning said two selected highest paying electronic advertisements according to advertiser constraints until there is a winning electronic advertisement.

23. A computer system for pricing electronic advertisements comprising:
a database operable to maintain electronic advertisements, advertiser data, and publisher data; and
a processor programed to:
receive a request for an electronic advertisement to be presented to a visitor;
calculate a projected ROI for each electronic advertisement considered for selection, wherein each said projected ROI is calculated using a contemporaneously calculated conversion probability, an advertiser value, and an impression cost;
calculate an impression price for said electronic advertisement for each electronic advertisement considered for selection having a projected ROI satisfying a ROI threshold, wherein said impression price is calculated using said contemporaneously calculated conversion probability and said advertiser value; and
select and return an electronic advertisement having a highest impression price.

24. The computer system of claim 23, further comprising considering expected revenue of fixed-rate electronic advertisements in selecting an electronic advertisement to return.

25. The computer system of claim 23 further comprising adjusting an impression price for each electronic advertisement as the lesser price of an advertiser's price constraint and said calculated impression price.

26. The computer system of claim 23, wherein said selecting and returning comprises auctioning electronic advertisements, having a calculated impression price, by incrementally increasing said calculated impression prices until individual price constraints for each electronic advertisement yield a winning electronic advertisement having a final impression price.

27. The computer system of claim 26, wherein only a portion of said electronic advertisements, comprising electronic advertisements having highest calculated prices, are considered for said auctioning.

28. The computer system of claim 23, wherein said ROI threshold is assignable and modifiable by an advertiser.

29. A computer-readable medium whose contents enable a computer system to select and price an electronic advertisement for presenting to a visitor, the computer system executing the contents of the computer-readable medium by performing a program comprising the steps of:
receiving a request for an electronic advertisement to be presented to a visitor;
calculating a projected ROI for each electronic advertisement considered for selection, wherein each said projected ROI is calculated using a contemporaneously calculated conversion probability, an advertiser value, and an impression cost;
calculating an impression price for said electronic advertisement for each electronic advertisement considered for selection having a projected ROI satisfying a ROI threshold, wherein said impression price is calculated using said contemporaneously calculated conversion probability and said advertiser value; and
selecting and returning an electronic advertisement having a highest impression price.

30. An Internet advertising system for pricing electronic advertisements, the system comprising:
a database operable for maintaining flexibly-priced electronic advertisements, fixed-rate electronic advertisements, and fixed-price electronic advertisements, advertiser constraints, conversion probabilities, advertiser data, and publisher data; and
a web server operable to:
receive data from advertisers;
receive a request for an electronic advertisement from a web browser;
calculate an expected revenue for each advertisement with flexible pricing selected for consideration, wherein said expected revenue for each said flexibly priced electronic advertisement is calculated by multiplying a real time conversion probability with an advertiser value;
calculate an expected revenue for cost-per-conversion ads by multiplying a real time conversion probability with an advertiser value;
calculate an expected revenue for cost-per-click ads by multiplying a real time click probability with an advertiser value;
rank all considered electronic advertisements by expected revenue;
choose a first and second best electronic advertisement by expected revenue;
decrease an expected revenue of said second best electronic advertisement by one bidding increment when said first and second best electronic advertisements have a same expected revenue;
set a price of said first best electronic advertisement to one increment more than an expected revenue of said second best electronic advertisement when said first best electronic advertisement has pricing flexibility;
set a price of flexibly-priced electronic advertisements to a greater price of a bidding increment and an advertiser's minimum price constraint when there is no second best electronic advertisement; and
return a highest-priced electronic advertisement to said web browser.
